(19) United States
(12) Patent Application Publication
(10) Pub. No.: US 2012/0055599 A1
(43) Pub. Date: Mar. 8, 2012

(54) SAFETY SYSTEM FOR VEHICLE TIRE BLOWOUT

(75) Inventor: Jim Ray Marentes Aguilar, Albuquerque, NM (US)

(73) Assignee: Mesa Digital, LLC.

(21) Appl. No.: 13/220,156

(22) Filed: Aug. 29, 2011

Related U.S. Application Data
(60) Provisional application No. 61/379,788, filed on Sep. 3, 2010.

(51) Int. Cl. B60C 17/02

(52) U.S. Cl. 152/152

(57) ABSTRACT

A safety system for a tire blowout in a vehicle is disclosed. The system can be activated when a tire blowout occurs. The system comprises of pellets arranged on the outer surface of the rim. The friction between the pavement, the rim, and the tire increases and heats the pellets when a tire blowout occurs. The pellets inflate inside the rim and cover a bigger space as soon as it heats up. The bigger sized pellets on the outer surface of the rim after blowout, acts like a secondary tire and avoids consequences of a tire blowout. The system can also comprise of a rim airbag which explodes as soon as the tire blows out and creates a pseudo tire. The safety system reduces the initial shock of the blowout and prevents losing control of the vehicle, Also, the system creates enough resistance to keep the vehicle in control and bring it to a safe speed. Note also that the “pseudo-tire” may be driven “X” amount of miles (under a certain speed), so the driver may drive to the nearest appropriate area.

### CROSS-REFERENCE TO PROVISIONAL APPLICATION

This patent application claims the benefit under 35 U.S.C. §119(e) of U.S. Provisional Application Ser. No. 61/379,788 entitled, “Safety System for Vehicle Tire Blowout,” which was filed on Sep. 3, 2010 and is incorporated herein by reference in its entirety.

### TECHNICAL FIELD

Embodiments are generally related to vehicle safety devices. Embodiments also relate to the field of safety devices for tire blowout in vehicles. Embodiments additionally relate to a system for stabilizing a vehicle when a tire blowout occurs.

### BACKGROUND OF THE INVENTION

Rapid tire deflation has been a problem since the dawn of the automobile. Rapid deflation can cause accidents on the road leaving a driver and passengers stranded in inhospitable situations. Various devices have been invented to prevent or mitigate the loss of air pressure in tires.

A blowout is a rapid loss of inflation pressure of a pneumatic tire. The primary cause for this is encountering an object that cuts or tears the structural components of the tire to the point where the structure is incapable of containing the pressurized air, with the escaping pressurized air adding to further tear through the tire structure.

A tire that can be run after loss of or reduction in pressure has been a desirable objective in the tire industry for some time. A tire that can be run in a deflated condition for an appreciable distance permits the driver to continue after the loss of or reduction in pressure or until a replacement tire can be obtained or the damaged tire is repaired. This would eliminate changing tires on the road and the need to depend on the serviceable condition of a spare tire that takes up considerable space in the vehicle. Also, such a safety tire would permit the driver to continue on some distance until a safe stopping place could be found thus avoiding sudden stopping on crowded streets, bridges, and highways. A number of tire safety systems have been developed to avoid the initial causes due to tire blowout.

In some prior art applications, a tire safety system can be mounted on a vehicle wheel rim inside a pneumatic tire. A tire air pressure sensor produces a tire air pressure reading mounted inside the tire. An inflatable member forms a toroidal expandable internal safety structure. The inflatable member is mounted against the vehicle wheel rim. The chemical container inside the inflatable member receives an electrical signal at an activation input. The chemical container creates pressurized gas inside the inflatable member for inflation when a signal is received at the activation input. A circumferential radially expandable protective belt mounted around the inflatable member expands with respect to the inflation of the inflatable member to accommodate the operation of the tire when expanded. A computer receiving tire air pressure readings from the tire air pressure sensor sends a signal to the activation input upon a sudden change in tire air pressure.

Another prior art discloses an accident prevention system for vehicles for stabilizing a vehicle when a tire loses pressure. The accident prevention system for vehicles includes a plurality of piston and cylinder actuators each positioned towards a unique tire of a vehicle. Lower ends of the piston and cylinder actuators are adapted for engaging a ground surface when the pistons are in an extended position. A plurality of sensors is each positioned towards a unique tire of the vehicle. Each of the sensors becomes activated when the associated tire goes flat. Each piston moves towards an extended position when the associated sensor is activated.

An airbag device for a vehicle tire capable of stabilizing the vehicle timely when the tire is exploding or being punctured suddenly to avoid potential accidents and to ensure driving comfort is disclosed in another prior art. The airbag device comprises a resilient outer ring installed between the tire and the wheel hub, and an inner ring serving to support the resilient outer ring. The resilient outer ring and the inner ring are compressed between the tire and the wheel hub under normal tire air pressure, and a space serving to increase driving comfortability and keep the outer ring from contacting the inner surface of the tire tread is designed between the resilient outer ring and the inner surface of the tire tread. When the tire is exploding or the air pressure of the tire is lost, the resilient outer ring is capable of bouncing instantly to support the weight of the vehicle.

The prior art systems should effectively reduce the initial shock of the blowout and easily prevent losing control of the vehicle. Further, the system should also provide enough resistance to keep the car in control and bring it to a safe speed. Also, the safety system should be simple in structure and compact in size. In an effort to address the foregoing difficulties, it is believed that the safety device for vehicle tire blowout as discussed herein can address many of the problems with traditional vehicle tire safety systems.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for vehicle safety devices.

It is another aspect of the disclosed embodiments to provide for safety devices for tire blowout in vehicles.

It is a further aspect of the present invention to provide for a system for stabilizing a vehicle when a tire blowout occurs.

The aforementioned aspects and other objectives and advantages can now be achieved as described herein. A safety system for a tire blowout in a vehicle is disclosed. The system can be activated when a tire blowout occurs. In one embodiment, the system comprises of pellets arranged on the outer surface of the wheel rim. When a tire blowout occurs, the friction between the pavement, the rim, and the tire increases and heats the pellets. The pellets inflate and cover a bigger space as soon as it heats up. The bigger sized pellets on the outer surface of the rim after a blowout acts like a secondary tire and avoids consequences of tire blowout.

In another embodiment, the system comprises of a rim airbag which explodes as soon as the tire blows out and creates a “pseudo tire.” The safety system reduces the initial shock of the blowout and prevents losing control of the vehicle. Also, the system creates enough resistance to keep the vehicle in control and brings it to a safe speed. Note also that the “pseudo-tire” may be driven “X” amount of miles (under a certain speed), so the driver may drive to the nearest appropriate area.

### BRIEF DESCRIPTION OF THE DRAWINGS

The accompanying figures, in which like reference numerals refer to identical or functionally-similar elements throughout the separate views and which are incorporated in and form a part of the specification, further illustrate the disclosed embodiments and, together with the detailed description of the invention, serve to explain the principles of the disclosed embodiments.

FIG. 1 illustrates a schematic block diagram of a vehicle, in accordance with the disclosed embodiments;

FIG. 2 illustrates a side view of a vehicle wheel of FIG. 1, in accordance with the disclosed embodiments;

FIG. 3 illustrates a cross-sectional view of a vehicle wheel as shown in FIG. 2 along line A-A, in accordance with the disclosed embodiments;

FIG. 4 illustrates a perspective view of a rim with pellets before a tire blowout, in accordance with the disclosed embodiments;

FIG. 5 illustrates a side view of a vehicle wheel after a tire blowout, in accordance with the disclosed embodiments;

FIG. 6 illustrates a cross-sectional view of a wheel as shown in FIG. 5 taken along line B-B, in accordance with the disclosed embodiments;

FIG. 7 illustrates a perspective view of a rim with pellets after a tire blowout, in accordance with the disclosed embodiments;

FIG. 8 illustrates a perspective view of a rim with an airbag, in accordance with another embodiment; and

FIG. 9 illustrates a side view of a rim with a pseudo tire created after a tire blowout, in accordance with another embodiment.

### DETAILED DESCRIPTION

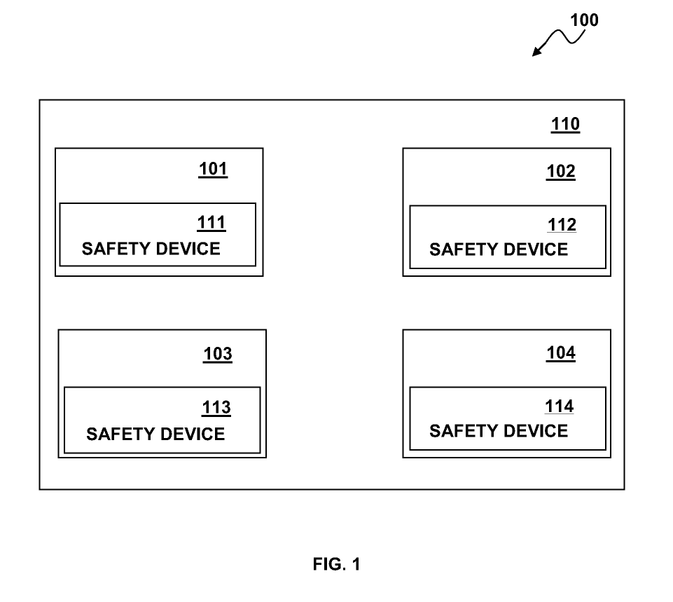

The particular values and configurations discussed in these non-limiting examples can be varied and are cited merely to illustrate at least one embodiment and are not intended to limit the scope thereof. Note that in FIGS. 1-9, identical or similar parts or elements are generally indicated by identical reference numerals.

The embodiments now will be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms such as those defined in commonly used dictionaries, should be interpreted as having a meaning that is consistent with their meaning in the context of the relevant art and will not be interpreted in an idealized or overly formal sense unless expressly so defined herein.

FIG. 1 illustrates a schematic block diagram of a vehicle safety system 100, in accordance with the disclosed embodiments. The safety devices (111, 112, 113, and 114) can be installed on the wheels (101, 102, 103, and 104) of the vehicle 110 respectively. The safety devices (111, 112, 113, and 114) are automatically activated to form a secondary tire (not show) when a tire blowout occurs. For an explanatory purpose, the wheel 101 and safety device 111 depicted in FIG. 1 are considered in the following figures. Note that the working and structure of all the safety devices (111, 112, 113, and 114) depicted in FIG. 1 are similar.

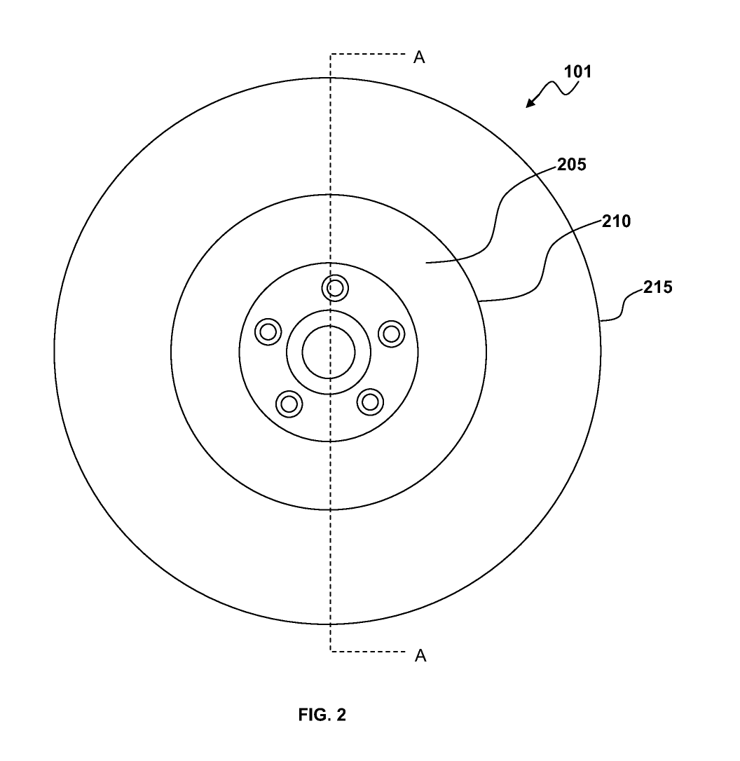

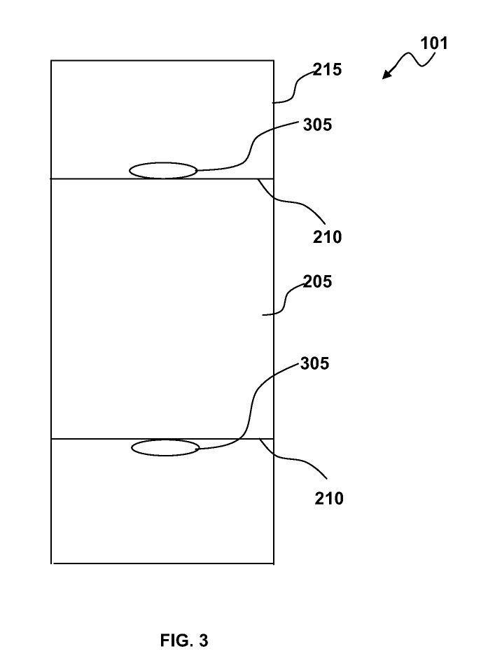

FIG. 2 illustrates a side view of a vehicle wheel 101, in accordance with the disclosed embodiments. FIG. 3 illustrates a cross-sectional view of a vehicle wheel 101 as shown in FIG. 2 along line A-A, in accordance with the disclosed embodiments. The safety device 111 depicted in FIG. 1 comprises of a plurality of pellets provided on the outer surface 210 of the rim 205. The pellets prevent initial shock of the vehicle 100 depicted in FIG, 1 when a blowout of tire 215 occurs.

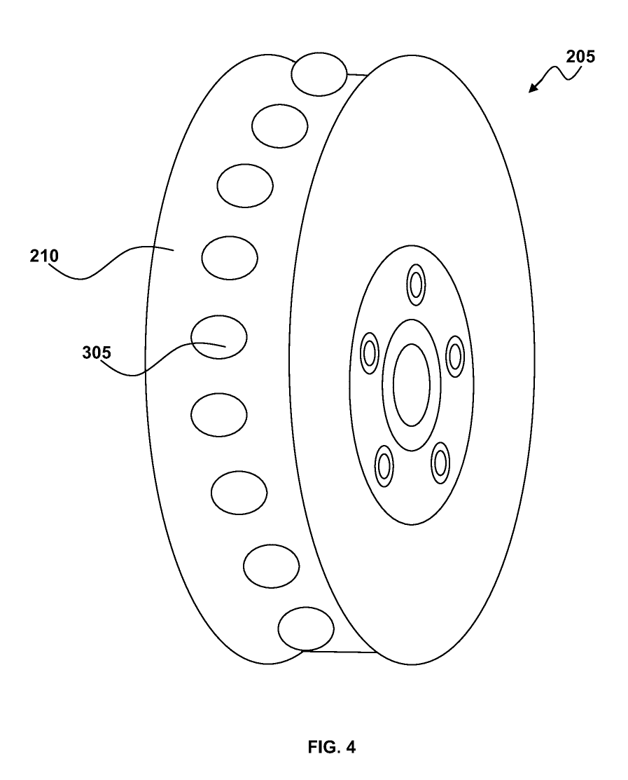

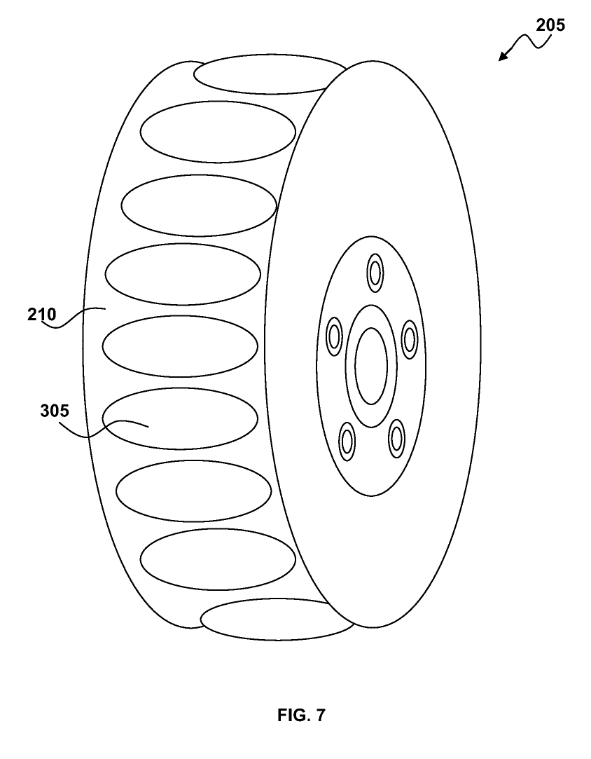

FIG. 4 and FIG. 7 illustrate a perspective view of a rim 205 with pellets 305 before and after a tire blowout, respectively, in accordance with the disclosed embodiments. The size and shape of pellets 305 before a blowout are normal as shown in FIG. 4. After a tire blowout, the pellets 305 become bigger than normal size as shown in FIG. 7. At the time of a tire blowout the friction between the pavement (not shown), tire 215, and rim 205 increases. This increase in friction heats the pellets 305 and makes them bigger in size. Such pellets 305 can act as a temporary or secondary tire for driving the vehicle 110 to a safe speed after a tire blowout.

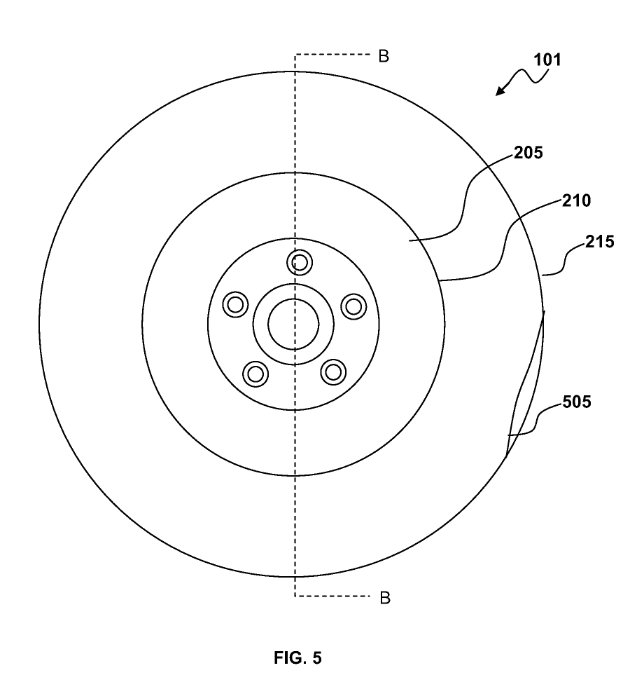

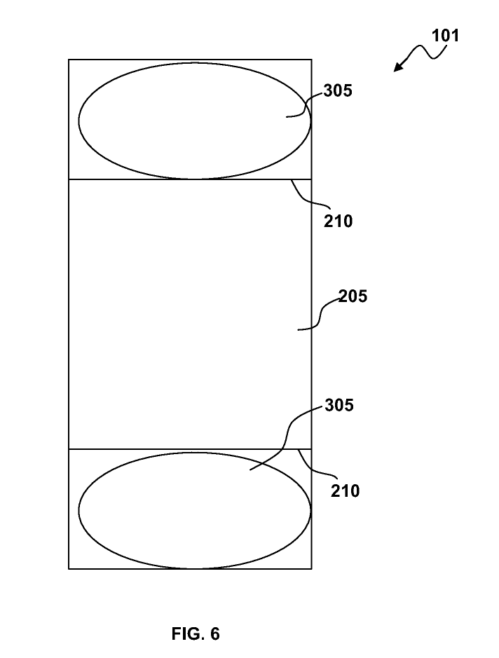

FIG. 5 illustrates a side view of a vehicle wheel 101 after a tire blowout 505, in accordance with the disclosed embodiments. FIG. 6 illustrates a cross-sectional view of a wheel 101 as shown in FIG. 5 taken along line B-B, in accordance with the disclosed embodiments. The pellets 305 can reduce the initial shock of the blowout 505 and prevent losing control of the vehicle 110. Also, pellets 305 create enough resistance to keep the vehicle 110 in control and bring the vehicle 110 to a safe speed.

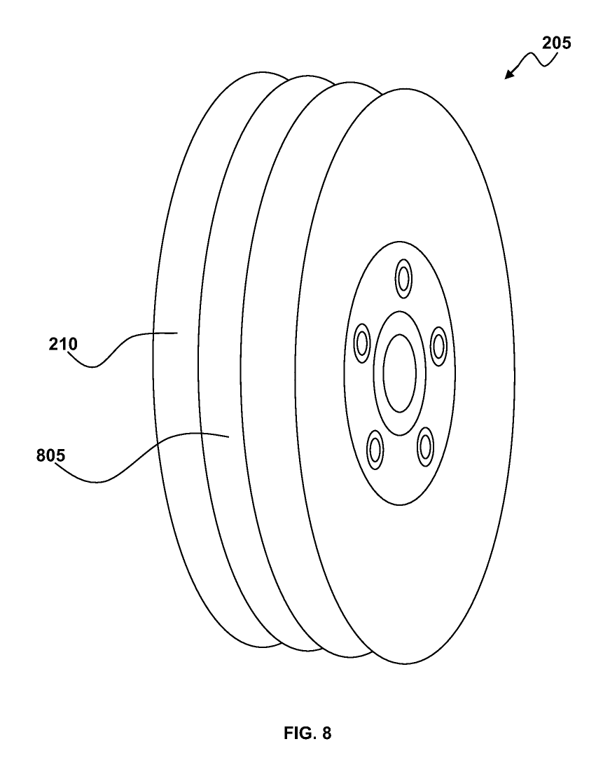

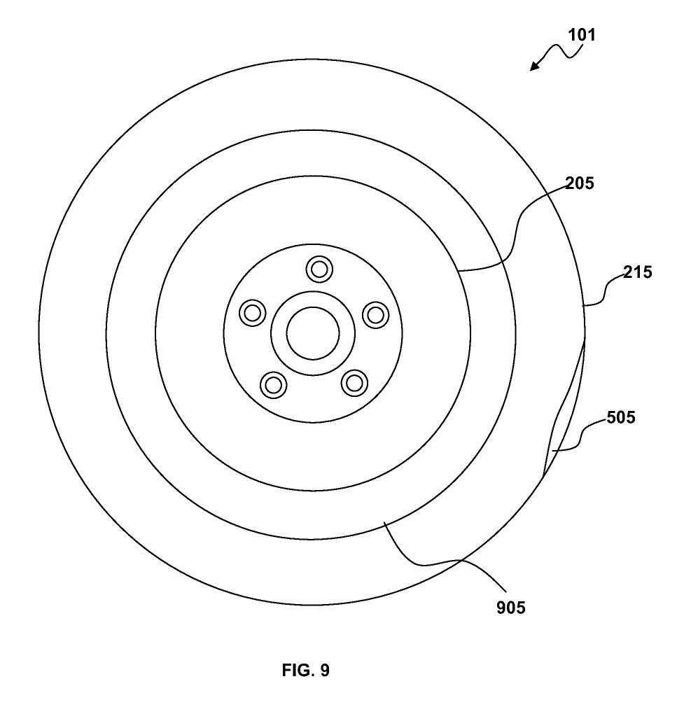

FIG. 8 illustrates a perspective view of a rim 205 with an airbag 805 before a tire blowout, in accordance with another embodiment. FIG. 9 illustrates a side view of a rim 205 with a pseudo tire 905 created after a tire blowout 505, in accordance with another embodiment. In another embodiment, the safety device 111 depicted in FIG. 1 comprises of airbag 805 to avoid initial causes due to a tire blowout. As soon as the tire 215 blows out, the airbag 805 explodes and creates a pseudo tire 905. The pseudo tire 905 is made of a suitable tire material that can resist the initial shock and avoid further blowout of pseudo tire. Note also that the “pseudo-tire” 905 may be driven “X” amount of miles (under a certain speed), so the driver may drive to the nearest appropriate area.

Based on the foregoing, it can be appreciated that a number of embodiments are disclosed herein. For example, in one embodiment a system for a tire blowout in a vehicle can be implemented. Such a system can include a safety device installed on a wheel of a vehicle, the safety device comprising a plurality of pellets arranged on an outer surface of a rim of the wheel, wherein after a blowout of the tire in the vehicle, the plurality of pellets inflates and acts as a secondary tire with respect to the wheel. In another embodiment, friction between the pavement/road, a tire, and the rim increases and heats the plurality of pellets. In another embodiment, the plurality of pellets can inflate as soon as heated. In still another embodiment, the plurality of pellets after a blowout reduces the initial shock of the blowout.

In yet another embodiment, the plurality of pellets after the tire blowout prevents losing control of the vehicle, creates enough resistance to keep the vehicle in control, and brings the vehicle to a safe speed. In still other embodiments, friction between the pavement/road, a tire, and the rim increases and heats the plurality of pellets and the plurality of pellets inflates as soon as heated. In still other embodiments, the plurality of pellets inflates as soon as heated and the plurality of pellets after a blowout reduces the initial shock of the blowout. In other embodiments, friction between the pavement/road, a tire, and the rim increases and heats the plurality of pellets and the plurality of pellets after a blowout reduces the initial shock of the blowout. In still other embodiments, friction between the pavement, a tire, and the rim increases and heats the plurality of pellets, the plurality of pellets inflates as soon as heated, and the plurality of pellets after a blowout reduces the initial shock of the blowout.

In still another embodiment, a system for a tire blowout in a vehicle can be implemented. Such a system can include a safety device installed on a wheel of the vehicle comprising an airbag provided on an outer surface of a rim of the wheel, and after the tire blowout in the vehicle, the airbag explodes and creates a secondary tire. In other embodiments, the secondary tire after the tire blowout reduces the initial shock of the blowout. In still other embodiments, the secondary tire after the tire blowout prevents losing control of the vehicle, creates enough resistance to keep the vehicle in control, and brings the vehicle to a safe speed. In yet other embodiments, the secondary tire after the tire blowout reduces the initial shock of the blowout, and the secondary tire after the tire blowout prevents losing control of the vehicle, create enough resistance to keep the vehicle in control, and bring the vehicle to a safe speed.

In yet another embodiment, a system for a tire blowout in a vehicle can be implemented, which includes a safety device installed on a wheel of a vehicle, the safety device comprising a plurality of pellets arranged on an outer surface of a rim of the wheel, wherein after a blowout of the tire in the vehicle the plurality of pellets inflates and acts as a secondary tire with respect to the wheel. In such an embodiment, the plurality of pellets after the tire blowout prevents losing control of the vehicle, creates enough resistance to keep the vehicle in control, and brings the vehicle to a safe speed.

It will be appreciated that variations of the above disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A system for a tire blowout in a vehicle, comprising:
a safety device installed on a wheel of a vehicle, said safety device comprising a plurality of pellets arranged on an outer surface of a rim of said wheel, wherein after a blowout of said tire in said vehicle said plurality of pellets inflates and acts as a secondary tire with respect to said wheel.

2. The system of claim 1 wherein friction between a pavement, a tire, and said rim increases and heats said plurality of pellets.

3. The system of claim 1 wherein said plurality of pellets inflates as soon as heated.

4. The system of claim 1 wherein said plurality of pellets after blowout reduces the initial shock of said blowout.

5. The system of claim 1 wherein said plurality of pellets after said tire blowout prevents losing control of said vehicle, creates enough resistance to keep said vehicle in control, and brings said vehicle to a safe speed.

6. The system of claim 1 wherein friction between a pavement, a tire and said rim increases and heats said plurality of pellets and wherein said plurality of pellets inflates as soon as heated.

7. The system of claim 1 wherein said plurality of pellets inflates as soon as heated and wherein said plurality of pellets after blowout reduces the initial shock of said blowout.

8. The system of claim 1 wherein friction between a pavement, a tire, and said rim increases and heats said plurality of pellets and wherein said plurality of pellets after blowout reduces the initial shock of said blowout.

9. The system of claim 1 wherein friction between a pavement, a tire, and said rim increases and heats said plurality of pellets, wherein said plurality of pellets inflates as soon as heated, and wherein said plurality of pellets after blowout reduces the initial shock of said blowout.

10. A system for a tire blowout in a vehicle, comprising:
a safety device installed on a wheel of said vehicle comprising an airbag provided on an outer surface of a rim of said wheel, wherein after said tire blowout in said vehicle said airbag explodes and creates a secondary tire.

11. The system of claim 10 wherein said secondary tire after said tire blowout reduces the initial shock of said blowout.

12. The system of claim 10 wherein said secondary tire after said tire blowout prevents losing control of said vehicle, creates enough resistance to keep said vehicle in control, and brings said vehicle to a safe speed.

13. The system of claim 10 wherein said secondary tire after said tire blowout reduces the initial shock of said blowout and wherein said secondary tire after said tire blowout prevents losing control of said vehicle, creates enough resistance to keep said vehicle in control, and brings said vehicle to a safe speed.

14. A system for a tire blowout in a vehicle, comprising:
a safety device installed on a wheel of a vehicle, said safety device comprising a plurality of pellets arranged on an outer surface of a rim of said wheel, wherein after a blowout of said tire in said vehicle said plurality of pellets inflates and acts as a secondary tire with respect to said wheel; and
wherein said plurality of pellets after said tire blowout prevents losing control of said vehicle, creates enough resistance to keep said vehicle in control, and brings said vehicle to a safe speed.

15. The system of claim 14 wherein friction between a pavement, a tire, and said rim increases and heats said plurality of pellets.

16. The system of claim 14 wherein said plurality of pellets inflates as soon as heated.

17. The system of claim 14 wherein said plurality of pellets after blowout reduces the initial shock of said blowout.

18. The system of claim 14 wherein friction between a pavement, a tire, and said rim increases and heats said plurality of pellets and wherein said plurality of pellets inflates as soon as heated.

19. The system of claim 14 wherein said plurality of pellets inflates as soon as heated and wherein said plurality of pellets after blowout reduces the initial shock of said blowout.

20. The system of claim 14 wherein friction between a pavement, a tire, and said rim increases and heats said plurality of pellets, wherein said plurality of pellets inflates as soon as heated and wherein said plurality of pellets after blowout reduces the initial shock of said blowout.
